(19) United States
(12) Patent Application Publication
(10) Pub. No.: US 2005/0259705 A1
(43) Pub. Date: Nov. 24, 2005

(54) Laser oscillation device

(75) Inventors: Yoshiaki Goto, Itabashi-ku (JP); Masayuki Momiuchi, Itabashi-ku (JP); Taizo Eno, Itabashi-ku (JP)

Correspondence Address: NIELDS & LEMACK, 176 EAST MAIN STREET, SUITE 7, WESTBORO, MA, 01581, US

(73) Assignee: Kabushiki Kaisha TOPCON

(21) Appl. No.: 11/114,654

(22) Filed: Apr. 26, 2005

(30) Foreign Application Priority Data
May 20, 2004 (JP) 2004-150216

(51) Int. Cl. H01S 3/04; H01S 3/16

(52) U.S. Cl. 372/41

(57) ABSTRACT

A laser oscillation device, comprising an optical crystal, wherein a heat radiation film with thermal conductivity higher than thermal conductivity of the optical crystal is formed at least on an end surface of the optical crystal where an excitation light enters.

### BACKGROUND OF THE INVENTION

The present invention relates to a laser oscillation device using a semiconductor laser as an excitation source.

First, description will be given on general features of a laser oscillation device 1.

FIG. 8 shows a diode-pumped solid-state laser of one-wavelength oscillation, which is an example of the laser oscillation device 1.

In FIG. 8, reference numeral 2 denotes a light emitting unit, and reference numeral 3 represents an optical resonator. The light emitting unit 2 comprises an LD light emitter 4 and a condenser lens 5. Further, the optical resonator 3 comprises a first optical crystal (a laser crystal 8) with a first dielectric reflection film 7 formed on the first optical crystal, a second optical crystal (a nonlinear optical crystal (NLO) (a wavelength conversion crystal 9)), and a concave mirror 12 with a second dielectric reflection film 11 formed on the concave mirror 12. A laser beam is pumped at the optical crystal resonator 3, and the laser beam is resonated, amplified and outputted. As the laser crystal 8, Nd:YVO₄ is used, and KTP (KTiOPO₄; titanyl potassium phosphate) is used as the wavelength conversion crystal 9.

Further, description is given as follows:

The laser oscillation device 1 projects a laser beam with a wavelength of 809 nm, for instance, and the LD light emitter 4, i.e. a semiconductor laser, is used. The LD light emitter 4 fulfills a function as a pumping light generator to generate an excitation light. In the laser oscillation device 1, the LD light emitter 4 is not limited to a semiconductor laser, and any type of light source means can be adopted so far as it can generate a laser beam.

The laser crystal 8 is used to amplify the light. As the laser crystal 8, Nd:YVO₄ with an oscillation line of 1064 nm is used. In addition, YAG (yttrium aluminum garnet) doped with Nd³⁺ ion, etc. are adopted. YAG has oscillation lines of 946 nm, 1064 nm, 1319 nm, etc. Ti (Sapphire) with an oscillation line of 700 to 900 nm, etc. may be used.

On a surface of the laser crystal 8 closer to the LD light emitter 4, the first dielectric reflection film 7 is formed. The first dielectric reflection film 7 is highly transmissive to the laser beam from the LD light emitter 4, and the first dielectric reflection film 7 is highly reflective to an oscillation wavelength of the laser crystal 8. The first dielectric reflection film 7 is also highly reflective to a secondary higher harmonic wave (SHG; second harmonic generation).

The concave mirror 12 is designed to face to the laser crystal 8. A surface of the concave mirror 12 closer to the laser crystal 8 is fabricated in form of a mirror with a concave spherical surface having an adequate radius. The second dielectric reflection film 11 is formed on the surface of the concave mirror 12. The second dielectric reflection film 11 is highly reflective to the oscillation wavelength of the laser crystal 8, and the second dielectric reflection film 11 is highly transmissive to the secondary higher harmonic wave.

As described above, when the first dielectric reflection film 7 of the laser crystal 8 is combined with the second dielectric reflection film 11 of the concave mirror 12. When the laser beam from the LD light emitter 4 is entered to the laser crystal 8 through the condenser lens 5, a light with a fundamental wave is oscillated. The oscillated light is pumped by running reciprocally between the first dielectric reflection film 7 of the laser crystal 8 and the second dielectric reflection film 11, and the light can be confined for long time. As a result, the light can be resonated and amplified.

The wavelength conversion crystal 9 is placed within the optical resonator, which comprises the first dielectric reflection film 7 of the laser crystal 8 and the concave mirror 12. When a specific laser beam enters the wavelength conversion crystal 9, a secondary higher harmonic wave to double a frequency of light is generated. The generation of the secondary higher harmonic wave is called “second harmonic generation”. Therefore, a laser beam with a wavelength of 532 nm is emitted from the laser oscillation device 1.

In the laser oscillation device 1 as described above, the wavelength conversion crystal 9 is disposed within the optical resonator, which comprises the laser crystal 8 and the concave mirror 12. This is called an intracavity type SHG. Because a conversion output is proportional to a square of excitation light photoelectric power, this provides an effect to directly utilize high optical intensity within the optical resonator.

In general, a semiconductor laser does not emit a laser beam of high output. Therefore, the diode-pumped solid-state laser using the laser beam from the LD light emitter 4 as an excitation light does not provide high output. However, to fulfill a demand to have higher output in recent years, there are the LD light emitters 4 which comprise a plurality of semiconductor lasers 13.

For instance, in the laser oscillation device disclosed in the Japanese Patent Application Publication No. 2003-124553, the LD light emitter 4 comprises a plurality of semiconductor lasers 13 as shown in FIG. 9. The plurality of semiconductor lasers 13 are arranged in form of an array. The laser beams emitted from the semiconductor lasers 13 are respectively converged to corresponding optical fibers 15 via a rod lens 14, and the optical fibers 15 are bundled together to a fiber cable 16. The light is turned to an excitation light 17 with high optical intensity, and this is entered to the laser crystal 8 to achieve high output.

When the excitation light 17 is entered to the laser crystal 8, the excitation light 17 is absorbed in the laser crystal 8, and excitation oscillation occurs on an end surface of the laser crystal 8. As a result, a part of energy of the excitation light 17 not absorbed is turned to heat. For this reason, temperature rise is at the highest on the incident end surface of the laser crystal 8 in the laser oscillation device of end surface excitation type.

When optical intensity of the excitation light entering the laser crystal 8, i.e. energy density of the excitation light, is increased, temperature of the laser crystal 8—in particular, temperature of the end surface—rises locally. In addition, because the laser crystal 8 itself has low thermal conductivity, optical and mechanical distortion occurs, and this may cause the decrease of laser oscillation. Further, if distortion increases, the crystal may be destroyed.

To cope with the temperature rise of the laser crystal 8 and of the wavelength conversion crystal 9 caused by the increase of optical intensity of the excitation light, it is practiced to cool down the laser crystal 8 and the wavelength conversion crystal 9. A cooling structure as shown in FIG. 10 is disclosed in the Japanese Patent Application Publication No. 2003-124553. In FIG. 10, the same component as shown in FIG. 8 and FIG. 9 is referred by the same symbol.

The light emitting unit 2 and the optical resonator 3 are fixed on a base 19, which serves as a heat sink. The light emitting unit 2 and the optical resonator 3 are arranged on an optical axis 10 (See FIG. 8). A lens unit 21 comprising the condenser lens 5 is disposed between the light emitting unit 2 and the optical resonator 3.

An optical resonator block 22 is fixed on the base 19. The optical resonator block 22 comprises the laser crystal 8 on the optical axis 10. The concave mirror 12 is provided on a surface of the optical resonator block 22 on an opposite side to the lens unit 21.

A recess 23 is formed in the optical resonator block 22 from above, and a wavelength conversion crystal 9 held by a wavelength conversion crystal holder 24 is accommodated in the recess 23. The wavelength conversion crystal holder 24 is tiltably mounted on the optical resonator block 22 via a spherical seat 25 so that an optical axis of the wavelength conversion crystal holder 24 can be aligned with the optical axis 10. A Peltier element 26 to cool down the wavelength conversion crystal 9 is arranged on the wavelength conversion crystal holder 24.

It is composed in such manner that the heat of the laser crystal 8 is radiated from the base 19 via the optical resonator block 22, and the wavelength conversion crystal 9 is cooled down by the Peltier element 26.

The laser crystal 8 is cooled down by thermal conduction from the laser crystal 8 to the optical resonator block 22, and further from the optical resonator block 22 to the base 19. The laser crystal 8 itself has poor thermal conductivity and its mechanical strength is also low. In order to increase thermal conductivity from the laser crystal 8 to the optical resonator block 22, it is proposed to promote close fitting between the laser crystal 8 and the optical resonator block 22 via soft metal such as indium, etc.

However, the highest temperature rise of the laser crystal 8 occurs on the end surface where the excitation light 17 enters. Because the excitation light 17 has high energy and high energy density, and because the laser crystal 8 itself has low thermal conductivity, heat input amount at the incident point of the excitation light 17 on the laser crystal 8 is larger compared with heat transfer amount caused by heat conduction. As a result, by the cooling operation based on heat conduction from the laser crystal 8 to the optical resonator block 22, it is difficult to suppress temperature rise on the end surface of the laser crystal 8. The temperature at the incident point rises to high temperature and steep temperature gradient is caused between the incident point and the surrounding region.

Therefore, in the cooling system in the past based on heat conduction from the laser crystal 8 to the optical resonator block 22, it is difficult to perform sufficient cooling at the incident point of the excitation light 17 on the laser crystal 8.

### SUMMARY OF THE INVENTION

It is an object of the present invention to provide a laser oscillation device, by which it is possible to cool down an optical crystal such as a laser crystal, a wavelength conversion crystal, etc., and, in particular, to effectively carry out the cooling on an end surface where an excitation light enters.

To attain the above object, the present invention provides a laser oscillation device, which comprises an optical crystal, and a heat radiation film with thermal conductivity higher than thermal conductivity of the optical crystal is formed at least on an end surface of the optical crystal where an excitation light enters. Also, the present invention provides the laser oscillation device as described above, wherein a heat radiation film continuous to the heat radiation film on the end surface is formed on a lateral surface of the optical crystal, and the optical crystal is held on the lateral surface by a heat sink. Further, the present invention provides the laser oscillation device as described above, wherein a cooling gas is flowed along the end surface. Also, the present invention provides the laser oscillation device as described above, wherein an opening is provided on a portion of the heat radiation film where the excitation light enters. Further, the present invention provides the laser oscillation device as described above, wherein an opening is provided on a portion of the heat radiation film where the excitation light enters, and the opening is designed in slit-like shape. Also, the present invention provides the laser oscillation device as described above, wherein the heat radiation film is formed by vacuum deposition. Further, the present invention provides the laser oscillation device as described above, wherein the heat radiation film is formed on an incident end surface and on an exit end surface, and size of the opening on the exit end surface is more than twice as large as a diameter of the converged excitation light.

According to the present invention, a laser-oscillation device comprises an optical crystal, and a heat radiation film with thermal conductivity higher than thermal conductivity of the optical crystal is formed at least on an end surface of the optical crystal where an excitation light enters. Therefore, a characteristic of heat radiation from the incident end surface is improved, and temperature rise of the incident end surface is suppressed.

According to the present invention, the laser oscillation device as described above, wherein a heat radiation film continuous to the heat radiation film on the end surface is formed on a lateral surface of the optical crystal, and the optical crystal is held on the lateral surface by a heat sink. As a result, a characteristic of heat radiation from the lateral surface of the optical crystal is improved, and temperature rise of the optical crystal is suppressed.

According to the present invention, a cooling gas is flowed along the end surface. Thus, a characteristic of heat radiation from the incident end surface is improved, and temperature rise of the incident end surface is suppressed.

### BRIEF DESCRIPTION OF THE DRAWINGS

FIG. 1 is a schematical drawing of an essential portion of a first embodiment of the present invention;

FIG. 2(A) and FIG. 2(B) each represents a schematical drawing of an incident end surface in the first embodiment of the present invention;

FIG. 3 is a schematical drawing of an essential portion of a second embodiment of the present invention;

FIG. 4 is a schematical drawing of an essential portion of a third embodiment of the present invention;

FIG. 5 is a schematical drawing of an essential portion of a fourth embodiment of the present invention;

FIG. 6 is a perspective view of a holding structure for a laser crystal in the present invention;

FIG. 7 is a schematical drawing of an essential portion of a fifth embodiment of the present invention;

FIG. 8 is a schematical drawing of a laser oscillation device;

FIG. 9 is a schematical drawing to show a case where a light emitting unit of the laser oscillation device comprises a plurality of semiconductor lasers; and

FIG. 10 is a cross-sectional view of a conventional type laser oscillation device.

### DETAILED DESCRIPTION OF THE PREFERRED EMBODIMENTS

Description will be given below on the best mode of the invention to carry out the present invention referring to the drawings.

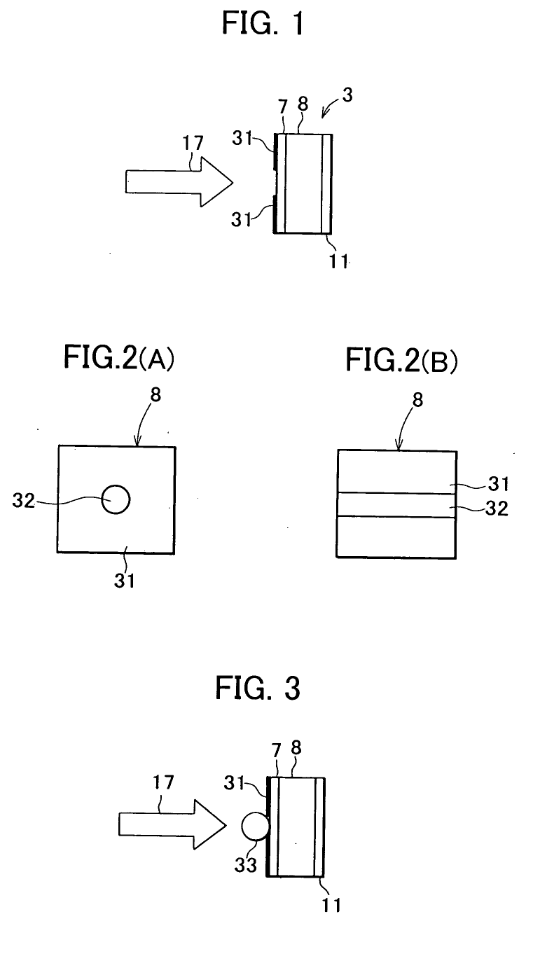

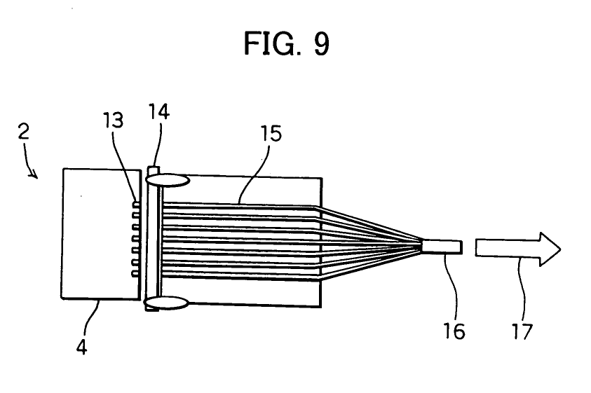

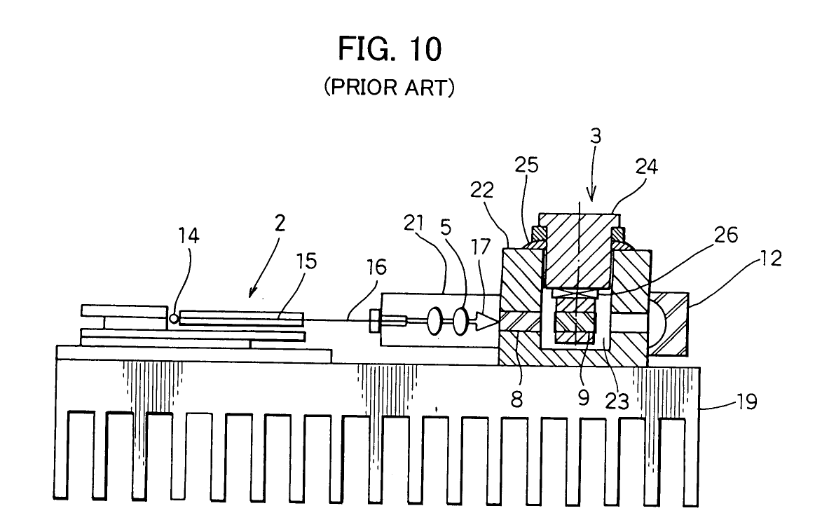

Referring to FIG. 1, description will be given on general features of a first embodiment of the present invention. FIG. 1 shows a laser oscillation device for emitting a fundamental wave oscillated without performing wavelength conversion in the optical resonator 3. In FIG. 1, a light emitting unit is not shown, and the same component as in FIG. 9 and FIG. 10 is referred by the same symbol.

On an end surface of a laser crystal 8 such as Nd:YVO₄ where an excitation light 17 enters, a first dielectric reflection film 7 is formed, which is highly transmissive to the excitation light 17 and is highly reflective to an oscillation wave (fundamental wave) of the laser crystal 8. On the other end surface of the laser crystal 8, a second dielectric reflection film 11 is formed, which is highly transmissive to the oscillation wave so that the laser crystal 8 fulfills a function as the optical resonator 3.

A heat radiation film 31 is formed to be layered on the first dielectric reflection film 7 by using a material with high thermal conductivity such as metal. As the material of the heat radiation film 31, a metal material such as Au, Cu, Al, and In, or a diamond-like carbon (DLC), etc. may be used for instance. As a method to form the film, a method such as electrocasting, vacuum deposition, etc. is adopted, which does not cause a physical gap between the first dielectric reflection film 7 and the heat radiation film 31.

An opening 32 to allow the excitation light 17 to enter is provided on the heat radiation film 31. The opening 32 may be designed in circular shape or in slit-like shape as shown in FIG. 2(A) and FIG. 2(B).

When the excitation light 17 enters the end surface of the laser crystal 8, a part of the excitation light 17 is turned to heat. The heat is transferred to the heat radiation film 31 with high thermal conductivity and is then radiated to the surroundings from the heat radiation film 31. Because the heat radiation film 31 has high thermal conductivity, generation of temperature distribution of heat on the end surface of the laser crystal 8 is suppressed, and also, generation of optical distortion and mechanical distortion are avoided.

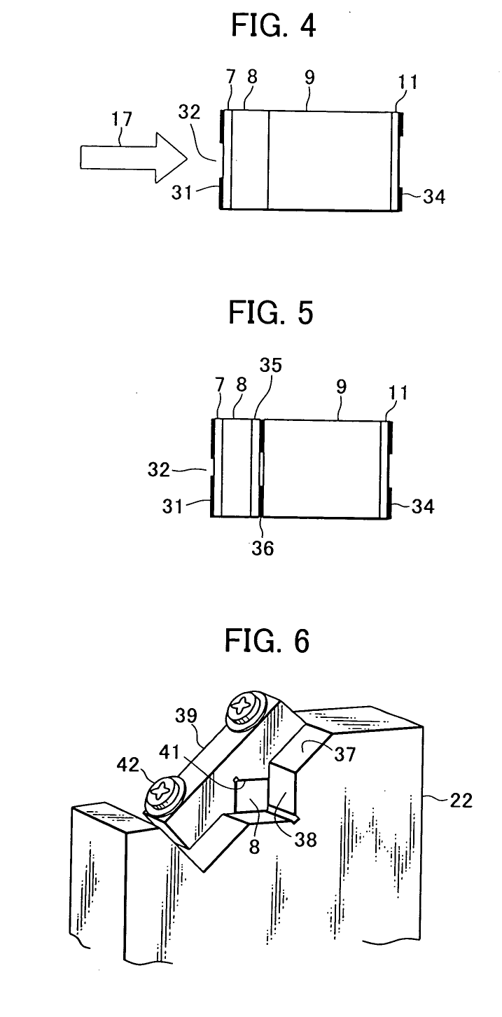

The heat radiation film 31 may be formed also on a lateral surface of the laser crystal 8 or on the end surface on exit side of the laser beam as shown in FIG. 4 for the purpose of expanding the heat radiating surface. When the heat radiation film 31 is formed on the end surface on exit side, the size of the opening is preferably more than twice as large as a diameter of the converged excitation light to prevent the influence of diffraction because the diameter of the outputted beam is defined as 1/e².

A second embodiment shown in FIG. 3 represents a case where a condenser lens 33 is mounted on the opening 32. In case the opening 32 is in circular shape, a ball lens or a cylinder lens or a fiber lens is used. The cylinder lens or the fiber lens is used to converge the light in a direction of a fast axis (direction perpendicular to an active layer) of the semiconductor laser 13.

A third embodiment shown in FIG. 4 represents a laser oscillation device of intracavity type SHG, in which the laser crystal 8 and the wavelength conversion crystal 9 are integrated with each other. For instance, Nd:YVO₄ is used as the laser crystal 8, and KTP is used as the wavelength conversion crystal 9.

On an incident end surface of the laser crystal 8, a first dielectric reflection film 7 is formed, which is highly transmissive to the excitation light 17 and is highly reflective to a fundamental wave and a secondary higher harmonic wave. On an exit end surface of the wavelength conversion crystal 9, a second dielectric reflection film 11 is formed, which is highly reflective to the fundamental wave and is highly transmissive to the secondary higher harmonic wave.

The excitation light 17, which enters the laser crystal 8, is oscillated into a fundamental wave on the end surface of the laser crystal 8, and the fundamental wave is pumped between the first dielectric reflection film 7 and the second dielectric reflection film 11. Wavelength conversion is performed by the wavelength conversion crystal 9, and the light is emitted after passing through the second dielectric reflection film 11.

Heat radiation is promoted by the heat radiation film 31 formed on the first dielectric reflection film 7, and temperature rise on the incident surface of the laser crystal 8 is suppressed. A heat radiation film 34 made of the same material as the material of the heat radiation film 31 is formed on the second dielectric reflection film 11, and heat radiation is also promoted by the heat radiation film 34. A heat radiation film may be formed on lateral surfaces of the laser crystal 8 and the wavelength conversion crystal 9 so that heat radiation can also be promoted from the lateral surfaces.

In a fourth embodiment shown in FIG. 5, the laser crystal 8 and the wavelength conversion crystal 9 are integrated with each other, and further a third dielectric reflection film 35 is formed between the laser crystal 8 and the wavelength conversion crystal 9. The third dielectric reflection film 35 is highly transmissive to a fundamental wave and is highly reflective to a secondary higher harmonic wave. When the third dielectric reflection film 35 is provided, a spacer 36 is interposed to interrupt optical continuity between the laser crystal 8 and the wavelength conversion crystal 9. The spacer 36 is provided by vacuum deposition of a metal film, for instance, and an opening is formed at a position of an optical path of the laser beam. The size of the opening should be more than twice as large as the diameter of the laser beam. The spacer 36 may be made of the same material as the material of the heat radiation film 31. Also, heat radiation films may be formed on lateral surfaces of the laser crystal 8 and the wavelength conversion crystal 9. The heat radiation films on the lateral surfaces may be made continuous to the spacer 36 so that the heat between the laser crystal 8 and the wavelength conversion crystal 9 may be radiated from the heat radiation films on the lateral surfaces via the spacer 36.

FIG. 6 shows a holding structure for the laser crystal 8.

A V-shaped recess is formed in an optical resonator block 22, which also serves as a heat sink. A V-shaped groove 38 is formed on a tilted surface 37 of the recess. On the laser crystal holder 39, which also serves as a heat sink, a V-shaped groove 41 which corresponds to the V-shaped groove 38 is formed. The laser crystal 8 is held between the V-shaped groove 38 and the V-shaped groove 41, and the laser crystal holder 39 is fixed on the tilted surface 37 by a bolt 42.

In the holding structure as described above, two lateral surfaces of the laser crystal 8 are pressed by the V-shaped groove 41 and the other two lateral surfaces are pressed by the V-shaped groove 38 securely. As a result, thermal conduction from the laser crystal 8 to the optical resonator block 22 and to the laser crystal holder 39 is increased. Further, to improve the close fitting between the laser crystal 8 and the optical resonator block 22 and between the laser crystal 8 and the laser crystal holder 39, soft metal such as indium, etc. is interposed. The heat radiation film 31 is formed at least on the incident end surface of the laser crystal 8, and a heat radiation film continuous to the heat radiation film 31 is formed on the lateral surface of the laser crystal 8.

The heat on the incident end surface of the laser crystal 8 is diffused to the surroundings from the heat radiation film 31 and is transferred toward the optical resonator block 22 and the laser crystal holder 39 through the heat radiation films on the lateral surfaces. As a result, temperature rise on the incident end surface is suppressed.

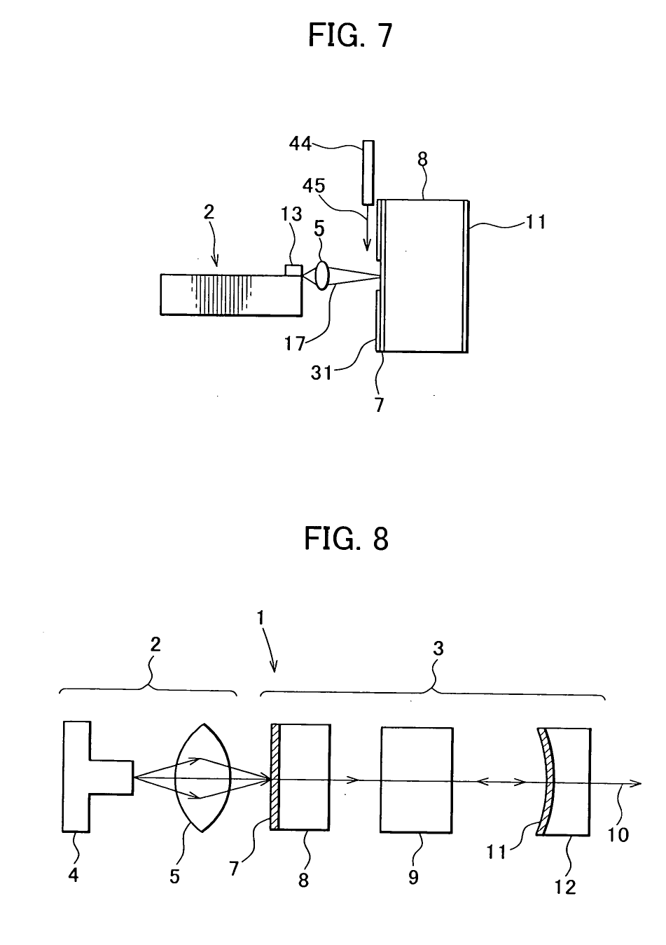

FIG. 7 shows a fifth embodiment, in which a characteristic of heat radiation from the heat radiation film 31 is improved further. The excitation light 17 emitted from the semiconductor laser 13 is converged to the incident side end surface of the laser crystal 8 by a condenser lens 5. A nozzle 44 with an opening near the incident end surface of the laser crystal 8 is disposed. From the nozzle 44, a cooling gas 45 is ejected so that the cooling gas 45 flows along the incident end surface. The gas flows adjacent to the heat radiation film 31. As a result, a characteristic of thermal conduction between the gas and the heat radiation film 31 is improved. This causes improvement of a characteristic of heat radiation from the end surface of the laser crystal 8, and temperature rise on the end surface of the laser crystal 8 is suppressed.

1. A laser oscillation device, comprising an optical crystal, wherein a heat radiation film with thermal conductivity higher than thermal conductivity of said optical crystal is formed at least on an end surface of said optical crystal where an excitation light enters.

2. A laser oscillation device according to claim 1, wherein a heat radiation film continuous to said heat radiation film on the end surface is formed on a lateral surface of said optical crystal, and said optical crystal is held on the lateral surface by a heat sink.

3. A laser oscillation device according to claim 1, wherein a cooling gas is flowed along said end surface.

4. A laser oscillation device according to claim 1, wherein an opening is provided on a portion of said heat radiation film where the excitation light enters.

5. A laser oscillation device according to claim 1, wherein an opening is provided on a portion of said heat radiation film where the excitation light enters, and said opening is designed in slit-like shape.

6. A laser oscillation device according to claim 1, wherein said heat radiation film is formed by vacuum deposition.

7. A laser oscillation device according to claim 4 or 5, wherein said heat radiation film is formed on an incident end surface and on an exit end surface, and size of the opening on the exit end surface is more than twice as large as a diameter of the converged excitation light.
